(19) United States
(12) Patent Application Publication
(10) Pub. No.: US 2003/0105231 A1
(43) Pub. Date: Jun. 5, 2003

(54) Polyester composition

(75) Inventor: Gerald W. Miller, Cincinnati, OH (US)

Correspondence Address: BANNER & WITCOFF, 1001 G STREET N W, SUITE 1100, WASHINGTON, DC, 20001, US

(73) Assignee: HITECH POLYMERS INC., Hebron, KY

(21) Appl. No.: 09/994,612

(22) Filed: Nov. 28, 2001

(51) Int. Cl. C08L 67/02

(52) U.S. Cl. 525/166

(57) ABSTRACT

Polyester compositions useful to improve the impact and heat distortion properties of polyethylene terephthalate, providing the polyethylene terephthalate with both high notched Izod properties and high heat distortion properties. The composition is the reaction of a terpolymer of ethylene, an acrylate or a methacrylate, and glycidyl methacrylate with polyethylene terephthalate in the presence of at least one elastomer such as a copolymer of ethylene and 1-octene.

### FIELD OF THE INVENTION

This invention relates to polyester compositions that improve the mechanical properties of blends of polyethylene terephthalate, and particularly compositions that improve impact behavior while providing high temperature heat distortion.

### BACKGROUND OF THE INVENTION

There is great interest in the use of polyethylene terephthalate (PET) as a basic engineering thermoplastic, as evidenced by the developments in the container industry. Numerous disclosures have been published for alloys and blends of PET with almost every other thermoplastic.

Because of technical difficulties, it has been difficult to modify the properties of PET to obtain both high impact and processibility. Prior art solutions to solve these difficulties include a wide variety of blending compositions and techniques, both for simple blends and more sophisticated compositions. Generally, immiscible blends exhibit poor mechanical properties while tending to process better. Impact modification of PET has been attempted using both immiscible blends and some reactive blends, providing a range of improvements from small to desirable.

Economically, the combination of very expensive polymers or large amounts of engineering polymers, such as polycarbonate, only tend to provide a material with the same economic level as the material being blended with PET. On the other hand, blending or alloying with some polyolefins, though they are of much lower cost, provides a material with poor mechanical properties. For example, in U.S. Pat. No. 5,994,467 to Farah et al., a polycarbonate/polyester/polyolefin blend is disclosed with a compatibilizer consisting of ethylene-methylacrylate-glycidyl methacrylate wherein the added ingredients tend to provide notched Izod values less than the native polycarbonate.

There have been a number of efforts to compatibilize PET with polyolefins with varying degrees of success. For example, in U.S. Pat. No. 5,618,881, Hojahr claims a compatibilizer composition comprising polyolefins, polyesters, a terpolymer of ethylene-methylacrylate and glycidyl methacrylate and a grafted polymer containing acrylic acid or maleic anhydride. Hojahr's data show that the maleic anhydride graft is more effective in increasing the notched Izod properties than the use of the epoxide terpolymer. In U.S. Pat. No. 5,747,591, Chen et al disclose the use of a terpolymer of ethylene-methylacrylate-glycidyl methacrylate as the compatibilizer for a broad variety of polyesters and polyamides for use in combinations with polyolefins for catheters and balloons in which the PET strengthens the usually soft polyolefin balloon.

Combinations of modifiers have been used for impact modification of PET. In U.S. Pat. No. 6,020,414 Nelsen et al describe the combination of an ethylene-alkylmethacrylate copolymer with an ethylene-alkylacrylate-glycidyl acrylate as an impact modifier for PET along with reinforcing agent and flame retardant.

There is a need in the technology of polyester for imparting both impact resistance and high heat distortion temperatures, as the usual impact resistance attempts have had low heat distortion temperatures, typical of the glass transition temperature of PET or thereabout.

### BRIEF SUMMARY OF THE INVENTION

The present invention is directed to a polyester composition having improved notched Izod impact and heat resistance over prior art polyethylene terephthalate. For example, the composition of the invention provides end products having notched Izod impact values of about 12 to about 16 ft. lbs./in. notch. In addition, the end products have high heat resistance upon release from a mold, typically about 180 to about 200° C.

The present invention is directed to a polyester composition comprising the reaction product of:

a. about 50 to about 85 wt % of polyethylene terephthalate, having an intrinsic viscosity of 0.5 to about 1.2 dl/g;

b. about 2 to about 20 wt % of a terpolymer of ethylene, methylacrylate or acrylate, and glycidylmethacrylate, having about 8 to about 35% glycidylmethacrylate component and a melt flow of about 3 to about 10 g/10 mm;

c. about 10 to about 40 wt % of an ethylene copolymer, with a melt flow of about 0.1 to about 10 g/10 min; and

d. 0 to about 25 wt % of polypropylene or an ethylene propylene copolymer, having a melt flow of about 6 to about 15 g/10 min.

In a preferred embodiment, the polyester composition comprises the reaction product of

a. about 70 to about 80 wt % of polyethylene terephthalate with an intrinsic viscosity of about 0.8 to about 1 dl/g;

b. about 3 to about 10 wt % of a terpolymer of ethylene, a methacrylate or an acrylate, and glycidyl methacrylate, having about 8 to about 35% glycidylmethacrylate component and a melt flow of about 3 to about 10 g/10 min;

c. about 10 to about 25 wt % of an ethylene-1-octene copolymer with a melt flow of about 0.1 to about 10 g/10 min; and

d. 0 to about 10 wt % of a copolymer of propylene with about 3 to about 6 wt % ethylene content, having a melt flow of about 6 to about 15 g/10 min.

### DETAILED DESCRIPTION OF THE INVENTION

The present invention provides a composition, which possesses high impact resistance and heat distortion temperatures, as well as ease of processing and molding. High impact is usually measured by notched Izod impact values. The present invention achieves at least 2.5 ft. lbs/in. notch, typically about 12 to about 16 ft. lbs./in. notch. The composition of the present invention results in end products having heat distortion temperatures of at least 170° C., typically about 180 to about 190° C. The polyester compositions also provide an end product that are semi-crystalline.

The polyester composition comprises the reaction product of:

a. About 50 to about 85 wt % of polyethylene terephthalate, having an intrinsic viscosity of about 0.5 to about 1.2 dl/g.

b. About 2 to about 20 wt % of a terpolymer of ethylene, a methylacrylate or an acrylate, and glycidylmethacrylate, having about 8 to about 35 wt % glycidylmethacrylate component and a melt flow of about 3 to about 10 g/l 0 min.

c. About 10 to about 40 wt % of an ethylene copolymer, with a melt flow of about 0.1 to about 10 g/10 min; and

d. 0 to about 25 wt % of polypropylene or an ethylene propylene copolymer, having a melt flow in the range of about 6 to about 15 g/l 0 min.

Component (a) is a polymer made from terephthalic acid and ethylene glycol. The amount of component (a) is preferably about 60 to about 85 wt %, more preferably about 70 to about 80 wt %. The intrinsic viscosity is preferably about 0.8 to about 1.2 dl/g, more preferably about 0.8 to about 1 dl/g.

The polyethylene terephthalate (PET) may be linear or branched. Linear PET is a commercial product, typically having intrinsic viscosities from 0.55 g/dl to 1.2 g/dl. Higher viscosities are usually prepared by subsequent solid phase polycondensation of lower molecular weight PET, first prepared by melt polymerization. Linear polyesters from terephthalic acid and cyclohexanedimethanol are prepared in a similar manner, creating a polymer called polycyclohexaneterephthalate (PCT). Branched PET can be made essentially the same way as linear PET with the exception that a minor amount of a tri- or higher functionality polyol or polyacid monomer is added to the polymerization. Trifunctional acids are usually preferred and of these, trimellitic anhydride or esters of trimellitic acid are preferred. Branching agents consist of 0.2 to 1.0 mole of trifunctional monomer per 100 moles of terephthalic acid, with 0.4 to 0.7 moles being preferred. Any suitable polyester based on a diol other than ethylene glycol with terephthalic acid or similar diacid, can be used to improve processing of compositions.

Component (b) is a terpolymer prepared from ethylene, an alkyl acrylate or a methacrylate, and glycidyl methacrylate. Such a terpolymer is commercially available as LOTADER AX-8900. The amount of component (b) is preferably about 3 to about 10 wt %. In a preferred embodiment, the terpolymer has about 32% glycidylmethacrylate component and a melt flow of about 6 g/10 min

Component (c) is an ethylene copolymer and is preferably ethylene-1-octene copolymer. The ethylene-1-octene may be prepared by copolymerization of 1-octene with ethylene in the presence of at least one catalyst. Such a copolymer is commercially available as ENGAGE EG8100. Alternatively, FLEXOMER 1085, a propylene/ethylene copolymer with a propylene content of 20-25%, can be used. The preferred amount of component (c) is about 10 to about 25 wt %. In a preferred embodiment the melt flow is about 1 g/10 min.

Component (d) is an optional ingredient and can be either a homopolymer of propylene or a copolymer with ethylene, with about 3 to about 6 wt % ethylene content. Such a copolymer is commercially available as SOLVAY 4550. Preferably, the amount of component (d) is 0 to about 10 wt %.

A preferred composition of the present invention is semi-crystalline and comprises a melt reaction (wherein components react in melt phase) of:

a. about 70 to about 80 wt % of polyethylene terephthalate with an intrinsic viscosity of about 0.8 to about 1;

b. about 3 to about 10 wt % of a terpolymer of ethylene, a methacrylate or an acrylate, and glycidyl methacrylate, having about 8 to about 35% glycidylmethacrylate component and a melt flow of about 3 to about 10 g/10 min;

c. about 10 to about 25 wt % of an ethylene-1-octene copolymer with a melt flow of about 0.1 to about 10 g/10 min; and

d. 0 to about 10 wt % of a copolymer of propylene with about 3 to about 6 wt % ethylene content, having a melt flow of about 6 to about 15 g/10 min.

The polyester compositions may contain minor amounts of a variety of additives, which are frequently used in plastics. These additives may or may not be reacted into the composition. Such additives include antioxidants, UV stabilizers, dyes, pigments, flame-retardants, reinforcing agents and fillers. Reinforcing fibers or fillers may be incorporated into the composition to the levels of about 10 to about 60 wt %, for example about 40%. Such fibers include glass fibers, carbon fibers, or combinations thereof.

Preferably, ingredients (a)-(c), optionally (d), and any other ingredients are combined in an extruder at a temperature of about 250° C. to about 350° C., preferably between about 280° C. and about 300° C. The components melt and react to form the reaction product.

### EXAMPLES

Polyester compositions were prepared using a Werner & Pfleiderer 53 mm twin screw extruder with trilobal screw geometries. These compositions were duplicated in their processing using a 58 mm bilobal Toshiba twin screw extruder. Both extruders were equipped with underwater pelletizers. A similar screw profile was used in each extruder as the feed section consisted of conveying elements followed by a small kneading section, using kneading blocks. This resulted in the melting of the polymer blend. The kneading section was followed by conveying elements for a short distance, followed by a kneading section with a reverse element to further assure shear and pressure to further the melting and mixing process. The reverse elements also serve to provide a melt seal. Then the melt is decompressed in the section under vacuum. Following the vacuum zone is a series of pumping elements, which move the melt through the die at the end of the extruder where the pelletizer cuts the polymer into pellets. The pellets are conveyed as a water slurry to a dewatering dryer and spun from the dryer onto a classifier for size control of the pellets.

### Example 1

A mixture of 80 lbs of PET, with an intrinsic viscosity of 0.84 and dried at 260 F for 4 hrs in a dessicant dryer, 5 lbs of Lotader AX 8900, and 15 lbs of Engage EG 8100 were fed to a 53 mm trilobal W&P twin screw extruder as separate feed streams at a rate of 200 lbs/hr. The temperature profile on the extruder, which had four temperature zones and an L/D of 36, was Zone 1(280° C.), Zone 2 (290° C.), Zone 3 (290° C.), Zone 4 (280° C.) with a die temperature of 300° C. The screw speed was 200 rpm and provided significant shear to melt, react and blend the components. Upon molding the pellets, after drying at 220° F. at 6 hrs, the physical properties were measured as shown in Table II.

### Examples 2-6

A variety of mixtures of PET, Lotader AX 8900, and Engage, and optionally a polypropylene copolymer, as shown in Table I, were extruded as in Example 1. The physical properties of the final product are shown in Table II.

### Example 7

Using the same conditions as those in Example 1, a blend of 65 lbs PET with an intrinsic viscosity of 0.84, 5 lbs Lotader AX8900, and 30 lbs of Flexomer 1085, an ethylene-propylene copolymer from Union Carbide, was extruded to yield the properties shown in Table II.

The ratios of blends used in this investigation were:

TABLE I

| | | LOTADER | ENGAGE | |
|---|---|---|---|---|
| PRODUCT | PET | AX8900 | 8100 | EPC |
| A | 80 | 5 | 15 | 0 |
| B | 75 | 5 | 20 | 0 |
| C | 65 | 5 | 30 | 0 |
| D | 80 | 5 | 5 | 10* |
| E | 65 | 10 | 25 | 0 |
| F | 65 | 5 | 30** | 0 |
| G | 100 | 0 | 0 | 0 |

**FLEXOMER 1085
*SOLVAY 4550

TABLE II

| PRODUCT | A | B | C | D | E | F | G |
|---|---|---|---|---|---|---|---|
| Tensile | 6350 | 4000 | 4320 | 4560 | 3430 | 4340 | 7500 |
| Strength, psi | | | | | | | |
| Elongation, % | 108 | 333 | 425 | 93 | 130 | 58 | 40 |
| Notched Izod, | 16 | 13 | 13 | 2.5 | 12 | 3.0 | 0.5 |
| ft. lbs/in. | | | | | | | |
| HDT, ° C. | 180 | 180 | 178 | 175 | 181 | 109 | 80 |
| Hardness, | 70 | 70 | 68 | 70 | 61 | 57 | 72 |
| shore D | | | | | | | |

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I claim:

1. A polyester composition comprising the reaction product of:
a. about 50 to about 85 wt % of polyethylene terephthalate, having an intrinsic viscosity of about 0.5 to about 1.2 dl/g;
b. about 2 to about 20 wt % of a terpolymer of ethylene, methylacrylate or acrylate, and glycidylmethacrylate, having about 8 to about 35 wt % glycidylmethacrylate component and a melt flow of about 3 to about 10 g/10 min;
c. about 10 to about 40 wt % of an ethylene copolymer, with a melt flow of about 0.1 to about 10 g/10 min; and
d. 0 to about 25 wt % of polypropylene or an ethylene propylene copolymer, having a melt flow of about 6 to about 15 g/10 min.

2. The composition of claim 1 comprising about 70 to about 80 wt % of polyethylene terephthalate

3. The composition of claim 1 wherein the intrinsic viscosity is about 0.8 to about 1 dl/g.

4. The composition of claim 1 wherein the terpolymer of ethyene, methylacrylate or acrylate, and glycidylmethacrylate has about 20 to about 35 wt % glycidylmethacrylate component.

5. The composition of claim 4 wherein the terpolymer has a melt flow of about 6 g/10 min.

6. The composition of claim 1 comprising about 3 to about 10 wt % of a terpolymer of ethylene, methylacrylate or acrylate, and glycidylmethacrylate.

7. The composition of claim 1 wherein the ethylene copolymer has a melt flow of about 0.5 to about 2 g/10 min.

8. The composition of claim 1 wherein the ethylene copolymer is an ethylene-l-octene copolymer.

9 The composition of claim 1 wherein the polypropylene or ethylene propylene copolymer has an ethylene content of about 3 to about 6 wt %.

10. The composition of claim 1 wherein the reaction is a melt reaction.

11. The composition of claim 1 further comprising about 10 to about 60 wt % of reinforcing fibers or fillers.

12. A polyester composition comprising the reaction product of:
a. about 70 to about 80 wt % of polyethylene terephthalate with an intrinsic viscosity of about 0.8 to about 1 dl/g;
b. about 3 to about 10 wt % of a terpolymer of ethylene, a methacrylate or an acrylate, and glycidyl methacrylate, having about 8 to about 35% glycidylmethacrylate component and a melt flow of about 3 to about 10 g/10 min;
e. about 10 to about 25 wt % of an ethylene-1-octene copolymer with a melt flow of about 0.1 to about 10 g/l 0 min; and
d. 0 to about 10 wt % of a copolymer of propylene with about 3 to about 6 wt % ethylene content, having a melt flow of about 6 to about 15 g/10 min.
